(19) United States
(12) Patent Application Publication
(10) Pub. No.: US 2007/0185883 A1
(43) Pub. Date: Aug. 9, 2007

(54) Multiple submits off a single web form

(76) Inventors: Indran Naick, Cedar Park, TX (US); Jeff K. Wilson, Austin, TX (US)

Correspondence Address: Greg Goshorn, P.C., 9600 Escarpment, Suite 745-9, AUSTIN, TX, 78749, US

(21) Appl. No.: 11/348,905

(22) Filed: Feb. 7, 2006

(51) Int. Cl. G06F 17/30

(52) U.S. Cl. 707/10

(57) ABSTRACT

Provided is a system and method for employing a single instantiation of a web form for multiple data requests. A user displays a form that the user would like to submit for multiple data requests. The user executes a form extension utility. The form extension utility either modifies the form to enable the entry of multiple data requests or generates and displays a data entry spreadsheet corresponding to the web form. Once the user has entered the required information, the form extension utility generates multiple queries. The user selects a format for the results and the form extension utility submits the multiple requests to the appropriate server. The server returns results for each submitted request. The form extension utility receives the results transmitted from the server, formats the results according to the user-selected format and displays the results.

### TECHNICAL FIELD

The present invention relates generally to computing systems and, more specifically, to a method for improving the efficiency of a graphical user interface associated with a computing system.

### BACKGROUND OF THE INVENTION

When computers were first invented, instructions, or programs, and data were entered manually via a series of switches. Soon, program and data entry was performed either by means of punch cards or keyboards coupled to the computing devices. Certainly, one of the primary advances in the computing arts has been the introduction of the graphical user interface (GUI). A GUI enables a user to enter data and commands and to execute programs by means of a keyboard and a computer mouse. Certainly, GUIs have become an indispensable part of the user/computer interface, particularly with the introduction of the Internet.

The Windows Explorer web browser, published by the Microsoft Corporation of Redmond, Wash., is one example of a GUI that enables users easy access to the Internet. In Windows Explorer, a display, or “desktop,” includes icons, or “buttons,” for programs that are either executing or may be executed and graphical displays, or “windows,” for programs that are active. Within individual windows, users typically access remote information sources via data entry templates, or “web forms.” A web form is presented to a user and the user inputs data into data entry fields. The browser converts the data in the data entry fields into a data query that is transmitted to an appropriate information repository, or “server.” The server executes the transmitted query and returns the requested information, which is then displayed to the user.

When multiple pieces of information are needed from a particular server, the data entry process becomes laborious because separate instantiations of the appropriate form must be filled in for each piece of information and each instantiation individually submitted. What is needed is a system and method for employing a single instantiation of a web form for multiple data requests, such that the user only needs to fill in a single form for multiple queries and the results are displayed in a user-defined manner.

### SUMMARY OF THE INVENTION

Provided is a system and method for employing a single instantiation of a web form for multiple data requests, such that a user only needs to fill in a single form for multiple queries and the results are displayed in a user-defined manner. The claimed subject matter extends the input capabilities of a single web form by either modifying the form or providing a spreadsheet that corresponds to the specific input options of the web form.

A user displays a form that the user would like to submit for multiple data requests. The user then executes a form extension utility by clicking on a corresponding button or pressing a pre-defined sequence of keystrokes. The form extension utility then either modifies the form to enable the entry of multiple data requests or generates and displays a data entry spreadsheet corresponding to the web form.

Once the user has entered the required information, the form extension utility generates multiple queries, each query based upon one associated set of the multiple inputs to the web form. The user selects a format for the results to be results and the form extension utility submits the multiple requests to the appropriate server. The server is not necessarily aware that the multiple forms have been generated by the form extension utility rather. The server returns results for each request. Finally, the form extension utility receives the results transmitted from the server, collates the results, formats them according to the user-selected format and displays the results in the selected format.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary computing system architecture that incorporates the claimed subject matter.

FIG. 2 is a block diagram of an exemplary desktop, introduced in FIG. 1, in greater detail.

FIG. 3 is a block diagram of an exemplary web form prior to being modified in accordance with the claimed subject matter.

FIG. 4 is a block diagram of the web form of FIG. 3 modified in accordance with the claimed subject matter.

FIG. 5 is an illustration of an exemplary spreadsheet employed to import data in one implementation of the claimed subject matter.

FIG. 6 is a flowchart of an Execute Form Extension Utility (FXU) process that implements one aspect the claimed subject mater.

FIG. 7 is a flowchart of a Convert Form process that implements one aspect of the claimed subject matter.

FIG. 8 is an illustration of some exemplary Result form returned by the execution of the FXU process of FIG. 6.

### DETAILED DESCRIPTION OF THE FIGURES

Although described with particular reference to a Microsoft Explorer, the claimed subject matter can be implemented in any information technology (IT) system and graphical user interface (GUI) in which efficiency in web form input is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for employing a single web form for multiple data requests. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

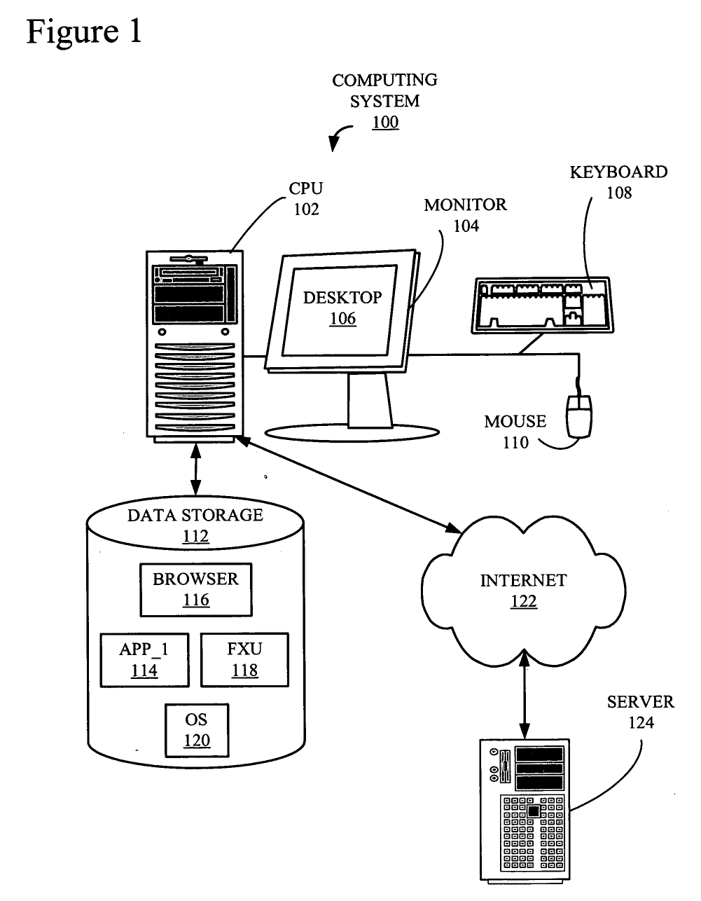

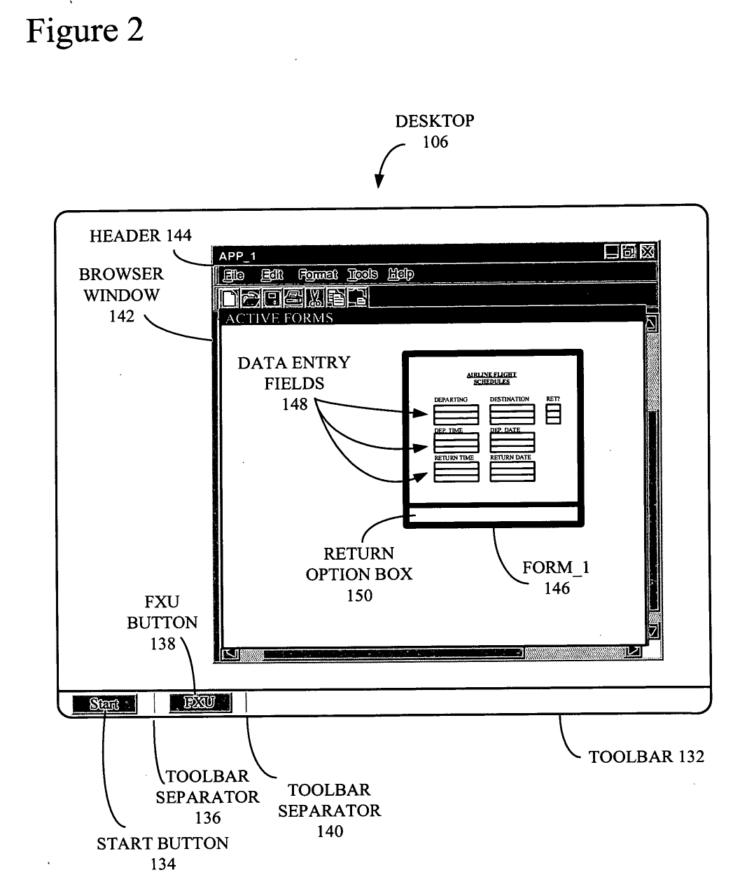

FIG. 1 is a block diagram of an exemplary computing system architecture 100 that incorporates the claimed subject matter. A central processing unit (CPU) 102 is coupled to a monitor 104, a keyboard 108 and a mouse 110, which together facilitate human interaction with CPU 102 and computing system 100. Monitor, or display, 104 presents a desktop 106 to a user. Desktop 106 is shown in more detail below in conjunction with FIG. 2.

Attached to CPU 102 is a data storage component 112, which may either be incorporated into CPU 102 i.e. an internal device, or attached externally to CPU 102 by means of various, commonly available connection devices such as but not limited to, a universal serial bus (USB) port (not shown). Data storage 112 is illustrated storing an exemplary application, “App_1,” 114 and a web browser, or browser, 116, which in this example is Microsoft Explorer. Both App_1 114 and browser 116 are used for the purpose of illustration only. It should be noted that a typical computing system may include many applications, but for the sake of simplicity only App_1 114 is shown.

Also stored on data storage 112 is a Form Extension Utility (FXU) 118, which implements the disclosed technology, and an operating system (OS) 120. Although shown as a separate module, in an alternative embodiment, FXU 118 may be incorporated into app_1 114, browser 116 or OS 120. In the following example, FXU 118 is initiated by a user of computing system 100 when the user displays a form that would benefit from multiple inputs. In this example, FXU 118 executes on CPU 102.

CPU 102 is controlled by operating system (OS) 120, which in this example includes a graphical user interface (GUI), illustrated below in conjunction with FIGS. 2-5 and 8. CPU 102 is connected to the Internet 122, which is also connected to a server computer 124. Although in this example, CPU 102 and server 124 are communicatively coupled via the Internet, they could also be coupled through any number of communication mediums such as, but not limited to, a local area network (LAN) (not shown). It should be understood that files such as App_1 114, browser 116 and FXU 118, as well as many other files accessed by CPU 102 may be stored on memory (not shown) coupled to server 124 and delivered over a LAN or the Internet 122 to CPU 102 and/or data storage 112.

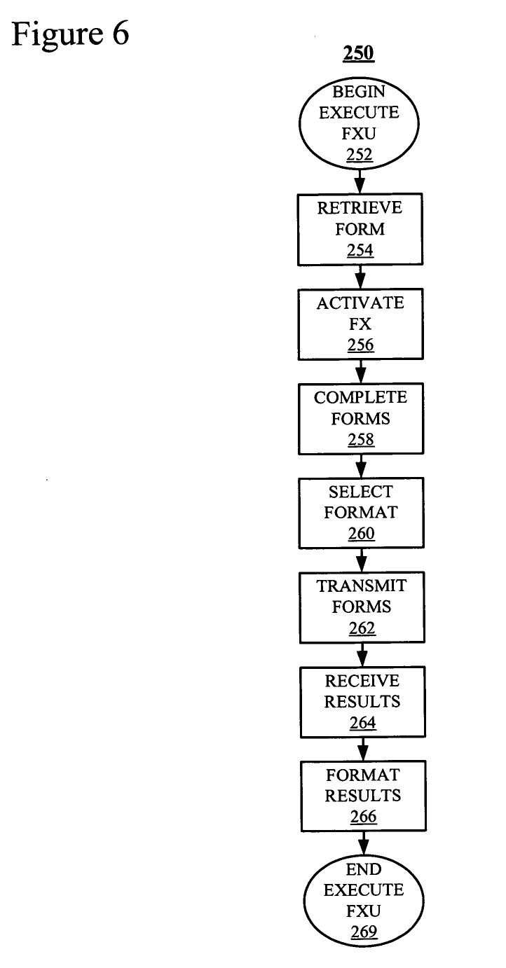

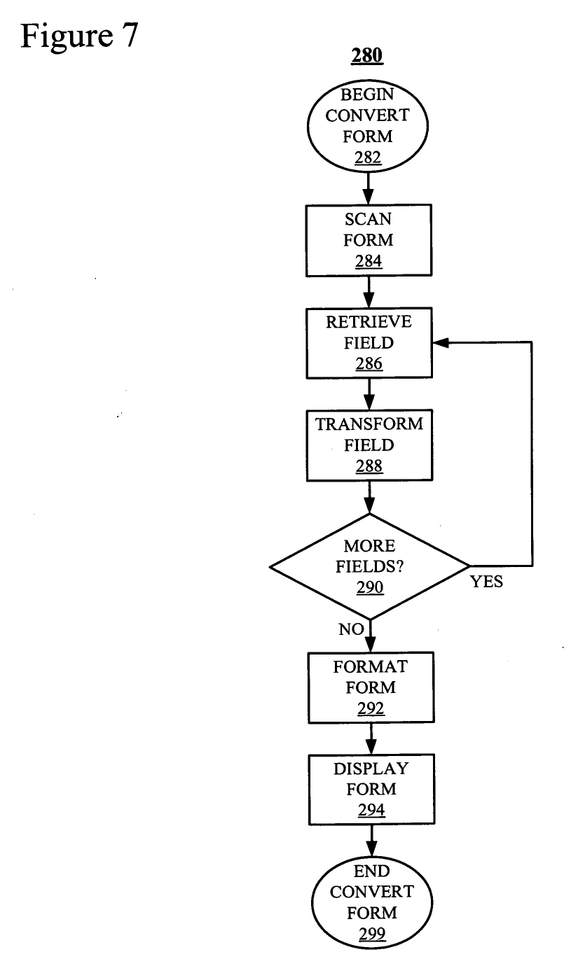

FIG. 2 is a block diagram of desktop 106, first introduced above in conjunction with FIG. 1, in greater detail. In this example, desktop 106 is part of a GUI displayed in conjunction with OS 120 (FIG. 1). A toolbar 132 extends along the bottom of desktop 106 from the left edge to the right edge of the screen associated with display 104 (FIG. 1). Within toolbar 132 are a “Start” button 134 and two toolbar separators 136 and 140. In between toolbar separators 136 and 140 is an area that will be referred to a “Quick Launch” area. Quick Launch area displays icons that initiate corresponding applications or utilities when the user positions a cursor (not shown) over a particular icon and presses, or “clicks,” a button (not shown) on mouse 110 (FIG. 1). A FXU button 138, shown within the Quick Launch area of toolbar 132, initiates an executable program associated with FXU 118. Processing associated with FXU 118 is described in more detail below in conjunction with FIGS. 6 and 7. Those with skill in the computing arts should be familiar with toolbars and quick launch as well as the use of mouse 110 and cursor to initiate actions on computing system 100. Further, it should be understood that icons are sometimes referred to as “buttons” in that actions occur when icons are clicked in much the same way that actions occur when physical buttons, such as those on mouse 110, are pressed.

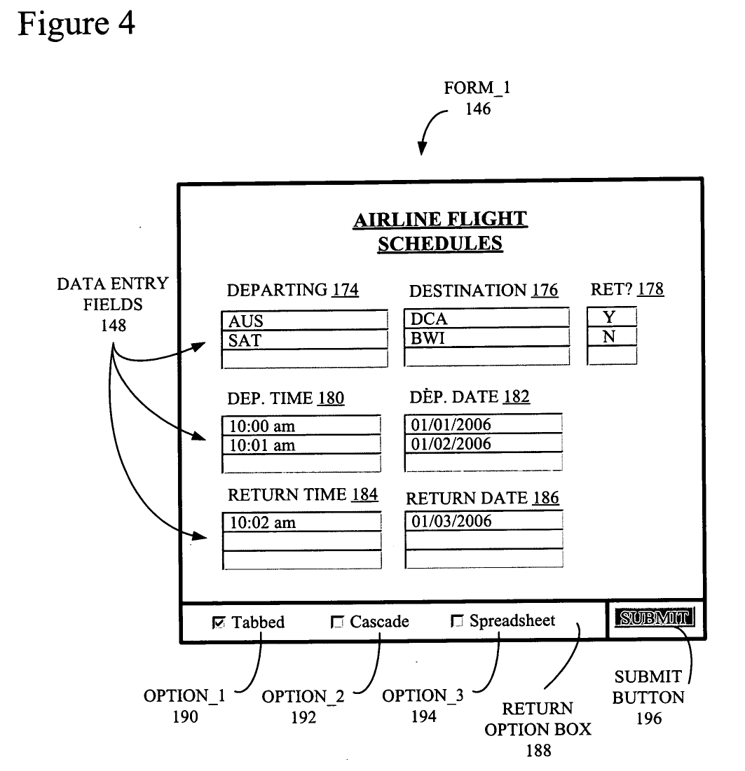

In FIG. 2, desktop 106 is displaying a browser window 142 associated with browser 116 (FIG. 1). Browser window 142 includes a header 144, which includes various icons associated with specific actions a user can execute with respect to items in browser window 142. In this example, browser window 142 is displaying a data entry form, form_1 146, which is associated with a web page that enables a user to determine airline flight schedules. Although described with respect to form_1 146 and its specific functionality, the claimed subject matter is applicable to any type of web forms used to transmit data. Data entry fields 148 are employed by a user to specify data to be transmitted, in this example information relating to airline flight transmitted to another computing system, such as server 124 (FIG. 1). Form_1 146 also includes a return option box 150. Form_1 146, data entry fields 148, return option box 150 and their applicability to the claimed subject matter is explained in more detail below in conjunction with FIG. 4. It should be noted, that window 142, form_1 146, data entry fields 148 and return option box 150 are used only as examples to describe the functionality of the claimed subject matter.

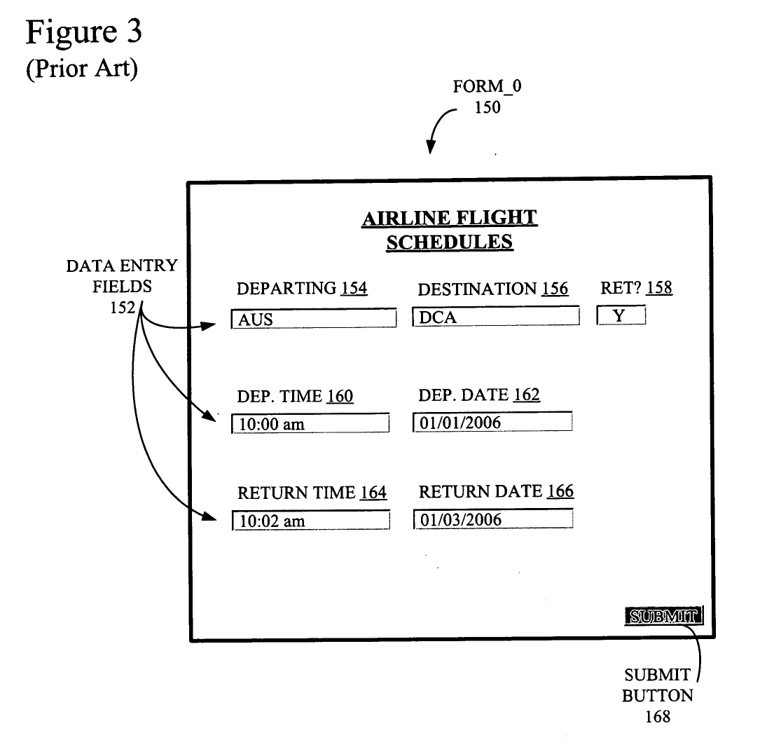

FIG. 3 is a block diagram of an exemplary, typical web form_0 150 prior to being modified in accordance with the claimed subject matter. Form_0 150 is a simplified example of a typical web form for retrieving information concerning airline flight schedules. Form_0 150 includes data entry fields 152. It should be noted that the particular fields 152 and the corresponding subject matter, i.e. airline flight information, are used for illustrative purposes only and that the claimed subject matter is applicable to any type of web form used for data entry. Data entry fields 152 are referred to as a “set” of data entry fields, indicating that together they are employed to generate a single information query

Data entry fields 152 include a “Departing” field 154, illustrated filled in with the airport code for Austin, Tex. (AUS). Departing field 154 is employed to enter a particular city from which the user wishes to depart. A “Destination” field 156 is employed to enter information relating to a destination city or airport, which in this example includes a reference to Dulles Airport (DCA) in Washington, D.C. A “Ret.?” field 158 is employed to indicate whether or not the user desires a return flight corresponding to the particular airplane ticket or, in other words, whether or not the requested information relates to a round-trip ticket or a one-way ticket. In this example, field 158, indicates that the user needs information for a round-trip ticket.

A “Departure (DEP.) Time” field 160 and a “Dep. Date” field 162 enable the user to enter a particular departure time and date. A “Return Time” field 164 and a “Return Date” field 166 enable the user to enter a particular time and date for a return flight. Of course, although an actual web page for retrieving information on airline flights would typically include more fields, for the sake of simplicity only data entry fields 154, 156, 158, 160, 162, 164 and 166 are illustrated. Finally, form_0 150 includes a “Submit” button 168, which the user clicks once data entry fields 152 are filled to transmit the completed information request to a server such as server 124 (FIG. 1).

FIG. 4 is a block diagram of exemplary web form_1 146 and data entry fields 148, both first introduced above in conjunction with FIG. 2, in more detail. Form_1 146 is a type of form generated by one embodiment of FXU 118 (FIG. 1), explained in more detail below, acting upon form_0 146 (FIG. 3).

Like data entry fields 152 (FIG. 3), data entry fields 148 include spaces for the user to input information relating to available airline flight schedules. Unlike data entry fields 152, each of data entry fields 148 has three (3) data entry lines, which are not individually labeled and during the remainder of this description will be referred to as line #1, line #2 and line #3, respectively. For example, a “Departing” field 174 is illustrated with a field 174, line #1 filled in with the airport code for Austin, Tex. (AUS); a field 174, line #2 with the code for San Antonio, Tex.; and a field 174, line #3 as unfilled. In other words, Departing field 174 is employed to enter a particular city from which the user wishes to depart. A “Destination” field 176 is employed to enter information relating to a destination city or airport, which in this example includes in field 176, line #1 a reference to Dulles Airport (DCA) in Washington, D.C. and in field 176, line #2 a referenced to the airport in Baltimore Md. (BWI). A “Ret.?” field 178 is employed to indicate whether or not the user desires a return flight corresponding to the particular airplane ticket or, in other words, whether or not the requested information relates to a round-trip ticket or a one-way ticket. In this example, field 178, line #1 indicates that the user needs information for a round-trip ticket and field 178, line #2 that the requested information is for a one-way trip. The corresponding lines of each data entry field correspond to a set of data entry fields in that data fields in corresponding lines are employed to generate a corresponding information query.

A “Departure (DEP.) Time” field 180 and a “Dep. Date” field 182 enable the user to enter a particular departure time and date. A “Return Time” field 184 and a “Return Date” field 186 enable the user to enter a particular time and date for a return flight. Note that because Ret? field 178, line #2 indicates that the requested information corresponds to a one-way trip, Return Time field 184, line #2 and Return Date field 186, line #2 do not include any information. Of course, although an actual web page for retrieving information on airline flights would typically include more fields, for the sake of simplicity only fields 174, 176, 178, 180, 182, 184 and 186 are illustrated. Further, it should be noted that data in each specific line of fields 174, 176, 178, 180, 182, 184 and 186 are related to a single information request.

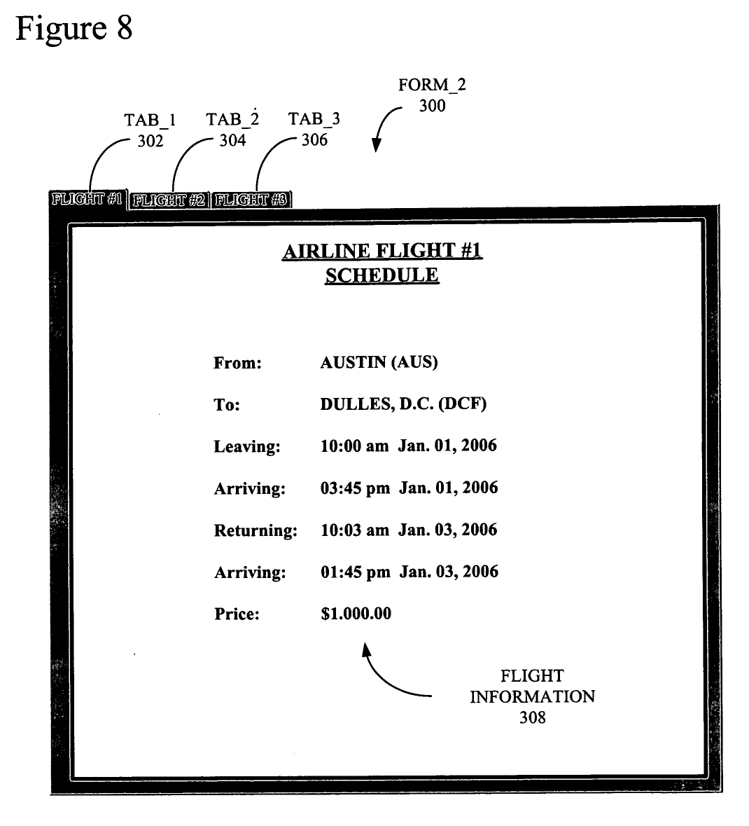

At the bottom of form_1 146 is a return option box 188 that includes three (3) possible formatting options for the response to a request for information. An option_1 check box 190 indicates that the user would like to see the retrieved information in a tabbed format; an option_2 check box 192 indicates a desire to see the information in a cascaded format; and an option_3 check box 194 indicates a desire to see the information in a spreadsheet format. In this example, the user has indicated a desire to see the information in a tabbed format as indicated by the check mark in option_1 check box 190 (see FIG. 8). It should be understood that in an actual implementation of the claimed subject matter, many more possible formatting options could be presented. For the sake of simplicity, only formatting options 190, 192 and 194 are illustrated.

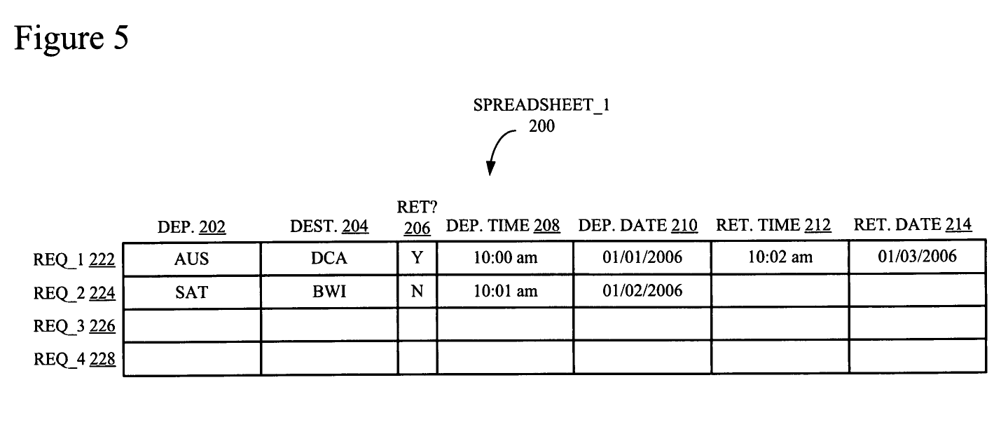

FIG. 5 is an illustration of an exemplary spreadsheet, i.e. a spreadsheet_1 200, that may be employed in conjunction with FXU 118 (FIG. 1). Spreadsheet_1 200 is displayed in a pop-up window (not shown) when a user clicks FXU button 138 (FIG. 2). It should be noted that the particular format of data entry associated with the claimed subject matter, e.g. form_1 146 (FIGS. 2 and 4) and spreadsheet_1 200, can be set via configuration parameters (not shown) associated with FXU 118. Those with skill in the computing arts should recognize that are may be many additional data entry techniques applicable to the claimed subject matter.

Like form_1 146 (FIGS. 2 and 4), spreadsheet_1 200 includes multiple data entry fields so that a user can enter information about airline flight schedules. A “Departing (Dep.)” column 202 corresponds to Departing data entry fields 174 (FIG. 4); a “Destination (Dest.)” column 204 corresponds to Destination data entry fields 176 (FIG. 4); a “Ret?” column 206 corresponds to Ret? data entry fields 178 (FIG. 4); a “Departure (Dep.) Time” column 208 corresponds to Dep. Time data entry fields 180 (FIG. 4); a “Dep. Date” column 210 corresponds to Dep. Date data entry fields 182 (FIG. 3); a “Return (Ret.) Time” column 212 corresponds to Ret. Time data entry fields 184 (FIG. 4); and a “Ret. Date” column 214 corresponds to Ret. Date data entry fields 186 (FIG. 4).

A “Req_1” row 222 of spreadsheet 200 corresponds to the first line, i.e. line #1, of data entry fields 174, 176, 178, 180, 182, 184 and 186 of form_1 146. In a similar fashion, a “Req_2” row 224 corresponds to the second line, i.e. line #2, of data entry fields 174, 176, 178, 180, 182, 184 and 186; and a “Req_3” row 226 corresponds to the third line, i.e. line #3, of data entry fields 174, 176, 178, 180, 182, 184 and 186. A fourth row, i.e. “Req_4” row 228, does not have a corresponding line in form_1 146, although there is no reason that form_1 146 could not display additional data entry lines or that spreadsheet_1 200 could not display fewer rows. Like the sets of data entry fields that correspond to each line of data entry fields 174, 176, 178, 180, 182, 184 and 186, each row 222, 224, 226 and 228 corresponds to an associated set of data entry fields. The specific number of lines in form_1 146 and rows in spreadsheet_1 200 depends upon configuration options and the data entry needs of the user. For the sake of comparison, spreadsheet_1 200 is illustrated with the same information in rows and columns as that shown in the corresponding data entry fields of form_1 146.

Spreadsheet_1 200 does not include data entry fields corresponding to return option box 188 (FIG. 4). In this embodiment, once the user fills in spreadsheet_1 200 and clicks on a “Submit” button (not shown) in the associated pop-up window to generate the associated queries (see FIG. 6), a second pop-up window (not shown) is displayed that enables the user to select configuration options to control the results of the queries.

FIG. 6 is a flowchart of an exemplary Execute Form Extension Utility (FXU) process 250 that implements the claimed subject mater. In this example, process 250 is represented by FXU 118 (FIG. 1), stored on data storage 112 (FIG. 1) and executed on CPU 102 (FIG. 1). Process 250 starts in a “Begin FXU” block 252 and proceeds immediately to a “Retrieve Form” block 254. During block 254, a user displays on desktop 106 (FIGS. 1 and 2) a data entry web form, which in this example is exemplified by form_0 150 (FIG. 3). During an “Activate FXU” block 256, while the focus of desktop 106 is on form_0 150, the user initiates FXU 118 by clicking on FXU button 138 (FIG. 2). FXU 118 transforms form_0 150 by expanding data entry fields 152 into data entry fields 148, thus giving the user additional data entry capability. As explained above in conjunction with FIG. 5, depending upon the particular configuration of FXU 118, spreadsheet_1 200 (FIG. 5) may be generated rather than form_1 146 to enable the user to complete multiple requests for information. Those with skill in the computing arts should appreciate how a form such as form_0 150 can be scanned and used to generate an alternative form, such as form_1 146, or some other data entry device, such as spreadsheet_1 200.

During a “Complete Forms” block 258, the user fills in data entry fields 148 of form_1 146 (or the rows and columns of spreadsheet_1 200 if so configured) with information corresponding to, in this example, the flights in which the user is interested in obtaining information. Once form_1 146 (or spreadsheet_1 200) is completed, during a “Select Format” block 260, the user clicks on one of option_1 190, option_2 192 or option_3 194 of return option box 188 to select a particular format for the display of the results of the generated queries. As explained above, a typical embodiment of the disclosed subject matter may include additional choices corresponding to the format of the display of the results.

Once data is entered during block 258 and a return format selected during block 260, the user initiates a “Transmit Forms” block 262 by clicking on Submit button 196 (FIG. 4). At this point, FXU 118 employs the information entered into data fields 148 into multiple data queries, each data query corresponding to the query that would be generated by form_0 150 if the associated data elements of each different lines, or sets, of data fields 174, 176, 178, 180, 182, 184, and 186 had been entered into the data fields 154, 156, 158, 160, 162, 164 and 166 (FIG. 3), respectively, of form_0 150 one line at a time and a corresponding data query generated. Each of the data queries is transmitted to server 124 (FIG. 1) as though a stand-alone query. The process of generating multiple data queries is explained in more detail below in conjunction with FIG. 7.

During a “Receive Results” block 264, FXU 118 receives the results of the data queries generated during block 262. From the view of server 124, each data query and the corresponding result is a separate query and result. During a “Format Results” block 266, FXU 118 formats and displays on desktop 106 the results received during block 264 in accordance with the formatting requests selected during block 260. One example of formatted results corresponding to the data illustrated as entered in FIG. 4 is shown below in conjunction with FIG. 8. Finally, process 250 proceeds to an “End Execute FXU” block 268 in which process 250 is complete.

FIG. 7 is a flowchart of an exemplary Convert Form process 280 that implements the claimed subject mater. In this example, process 280 is executed once a user activates FXU 118 (FIG. 1) during Activate FXU block 256 (FIG. 6) of process 250 (FIG. 6) and is executed on CPU 102 (FIG. 1). This description is based upon form_0 150 and corresponding data entry fields 154, 156, 158, 160, 162, 164 and 166 (FIG. 3).

Process 280 starts in a “Begin Convert Form” block 282 and proceeds immediately to a “Scan Form” block 284. During block 284, process 280 scans form_0 150 (FIG. 3) to identify data entry fields 152 (FIG. 3). During a “Retrieve Field” block 286, selects an unprocessed data entry field, such as, in this example, data entry field 154 and, during a “Transform Field” block 288, converts the field to a multiple entry filed, such as data entry fields 174, lines #1-3 (FIG. 4) of form_1 146 (FIGS. 2 and 4).

During a “More Fields?” block 290, process 280 determines whether or not form_0 150 has unprocessed data entry fields 152. If so, process 280 returns to block 286, retrieves the next unprocessed data entry filed, such as data entry field 156, and processing continues as described above. If during block 290 process 280 determines that all data entry fields 154, 156, 158, 160, 162, 164 and 166 have been processed, i.e. converted to data fields 174, 176, 178, 180, 182, 184 and 186 (FIG. 4), respectively, control proceeds to a “Format Form” block 292, during which process 280 redraws, or converts, form_0 150 to look and function like form_1 146.

During a “Display Form” block 294, process 280 displays the converted form_0 150, i.e. form_1 146, on desktop 106 (FIGS. 1-2) as illustrated in FIG. 4. Finally, control proceeds to an “End Convert Form” block 299 in which process 280 is complete.

FIG. 8 is an illustration of an exemplary Result form_2 300 returned by the execution of FXU 118 (FIG. 1) acting upon the information entered into form_1 146 (FIGS. 2 and 4), as illustrated above in FIG. 4. Form_2 300 includes three tabs: a tab_1 302, a tab_2 304 and a tab_3 306. Tab_1 302 is the active tab, i.e. any information displayed in tab_2 304 and tab_3 306 is obscured by the display of tab_1302. Tab_1 302 displays flight information 308 corresponding to the information entered in line #1 of data entry fields 174, 176, 178, 180, 182, 184 and 186. If tab_2 304 was clicked, flight information corresponding to the data entered in line #2 of data entry fields 174, 176, 178, 180, 182, 184 and 186 would be displayed on desktop 106.

The tabbed format of form_2 300 is dictated by the selection of option_1 190 (FIG. 4) on form_1 146. It should be noted that each of tab_1 302, tab_2 304 and tab_3 306 represents a collated result that displays a standard result form corresponding to a query generated by form_0 150. The information required for a query and the specific information returned would depend upon the web site to which the query is directed. FXU 118 (FIG. 1) is responsible for generating multiple single query forms such as form_0 150 into multiple queries and then arranging the corresponding responses into the tabbed format illustrated in FIG. 8. In this manner, FXU 118 can be employed to extend the functionality of most web query forms, regardless of the particular information requirements of the corresponding web sites.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for generating web information requests, comprising:
scanning a web form for a set of data entry fields;
generating two or more sets of data entry fields corresponding to the scanned set of data entry fields;
displaying the two or more sets of generated data entry fields rather than the set of scanned data entry fields;
generating a plurality of information queries, each information query corresponding to one of the sets of generated data entry fields and based upon information entered in corresponding data entry fields of the sets generated data entry fields; and
transmitting the plurality of information queries to an information server.

2. The method of claim 1, further comprising:
receiving results from the two of more information queries;
formatting the results from the two or more information queries; and
displaying the results from the two or more information queries.

3. The method of claim 2, further comprising collating the received results with respect to the associated information queries prior to the formatting.

4. The method of claim 2, further comprising defining parameters to control the formatting of the results.

5. The method of claim 4, wherein the formatting of the results displays the results as one of a tabbed, cascaded or spreadsheet format.

6. The method of claim 1, wherein the generated sets of data entry fields are formatted in a style consistent with the scanned set of data entry fields and displayed in the web form.

7. The method of claim 1, wherein the generated sets of data entry fields are formatted as a spreadsheet.

8. A system for generating web information requests, comprising:
a web form comprising a first set of data entry fields;
logic for generating two or more sets of data entry fields corresponding to the first set of data entry fields;
logic for displaying the two or more sets of generated data entry fields rather than the first set of data entry fields;
logic for generating a plurality of information queries, each information query corresponding to one of the sets of generated data entry fields and based upon information entered in corresponding data entry fields of the sets generated data entry fields; and
logic for transmitting the plurality of information queries to an information server.

9. The system of claim 8, further comprising:
logic for receiving results from the two of more information queries;
logic for formatting the results from the two or more information queries; and
logic for displaying the results from the two or more information queries.

10. The system of claim 9, further comprising logic for collating the received results with respect to the associated information queries prior to executing the logic for formatting.

11. The system of claim 9, further comprising parameters to control the logic for formatting the results.

12. The system of claim 11, wherein the logic for formatting the results displays the results as one of a tabbed, cascaded or spreadsheet format.

13. The system of claim 8, wherein the generated sets of data entry fields are formatted in a style consistent with the scanned set of data entry fields and displayed in the web form.

14. The system of claim 8, wherein the generated sets of data entry fields are formatted as a spreadsheet.

15. A computer programming product for generating web information requests, comprising:
a memory;
a web form, stored on the memory, comprising a first set of data entry fields;
logic, stored on the memory, for generating two or more sets of data entry fields corresponding to the first set of data entry fields;
logic, stored on the memory, for displaying the two or more sets of generated data entry fields rather than the first set of data entry fields;
logic, stored on the memory, for generating a plurality of information queries, each information query corresponding to one of the sets of generated data entry fields and based upon information entered in corresponding data entry fields of the sets generated data entry fields; and
logic, stored on the memory, for transmitting the plurality of information queries to an information server.

16. The computer programming product of claim 15, further comprising:
logic, stored on the memory, for receiving results from the two of more information queries;
logic, stored on the memory, for formatting the results from the two or more information queries; and
logic, stored on the memory, for displaying the results from the two or more information queries.

17. The computer programming product of claim 16, further comprising logic, stored on the memory, for collating the received results with respect to the associated information queries prior to executing the logic for formatting.

18. The computer programming product of claim 16, further comprising parameters, stored on the memory, to control the logic for formatting the results.

19. The computer programming product of claim 15, wherein the generated sets of data entry fields are formatted in a style consistent with the scanned set of data entry fields and displayed in the web form.

20. The computer programming product of claim 15, wherein the generated sets of data entry fields are formatted as a spreadsheet.
